(19) United States
(12) Patent Application Publication
(10) Pub. No.: US 2024/0364243 A1
(43) Pub. Date: Oct. 31, 2024

(54) MOTOR DRIVE ASSEMBLY

(71) Applicant: ZF Automotive UK Limited

(72) Inventors: Ari Al-Jaf, Birmingham (GB); Harvey Smith, Birmingham (GB)

(21) Appl. No.: 18/647,293

(22) Filed: Apr. 26, 2024

(30) Foreign Application Priority Data
Apr. 28, 2023 (GB) 2306388.6

(51) Int. Cl. H02P 6/10; H02K 7/116; H02K 29/08

(52) U.S. Cl. CPC H02P 6/10; H02K 7/1166; H02K 29/08

(57) ABSTRACT

A drive system comprises at least two electric motor subassemblies, each comprising a rotor and a stator. The rotors are connected to a mechanical load to fix a position between the two rotors. The system further comprises: first and second position sensing assemblies that provide first and second rotor position signals of first and second motor subassemblies, respectively. Each position signal is indicative of the position of the associated rotor relative to its associated stator including a periodic pattern of errors in the indicated position of the rotor. A motor controller controls the currents applied to each motor subassembly as a function of the position signal. The current causes each rotor to apply a force to the mechanical load which includes a force ripple due to periodic errors in position signals, in which: the orientation of the first and second rotor position sensing assemblies relative to the first and second motor subassemblies are fixed such that the periodic ripple in the forces applied by the two motors are seen by the mechanical load at least partially cancel out.

### CROSS-REFERENCE TO RELATED APPLICATION

This application claims priority to United Kingdom application No. 2306388.6, filed on Apr. 28, 2023, the disclosure of which is incorporated herein by reference in its entirety.

### TECHNICAL FIELD

This disclosure relates to a motor drive assembly, in particular but not exclusively, to motor drive assemblies having two or more motors connected to a common output or to a single motor having multiple motor subassemblies each connected to a common output.

### BACKGROUND

Motors may be rotary or linear, and may be electrically or otherwise powered. In this description to the term rotor is used to refer to the moving part of a rotary motor which rotates and the moving part of a linear motor which translates.

Electric motors are widely used and are increasingly common in automotive applications. For example, it is known to provide an electrically power assisted steering system in which an electric motor apparatus applies an assistance torque to a part of a steering system to make it easier for the driver to turn the wheels of the vehicle. The magnitude of the assistance torque is determined according to a control algorithm which receives as an input one or more parameters such as the torque applied to the steering column by the driver turning the wheel, the vehicle speed and so on.

Another example of use of electric motors in automotive applications is in steer-by-wire systems. During normal use, these systems have no direct mechanical link from the hand wheel that the driver grips and the steered wheels with movement of the hand wheel by the driver being detected by a sensor and the motor being driven in response to the output of the sensor to generate a force that steers the road wheels. These systems rely on sensors to relay user input data at a steering wheel to control units which integrate user input data with other information such as vehicle speed and yaw rate, to deliver control signals to a primary motor that physically actuates a steering rack of the vehicle. The control units also act to provide a response signal to a secondary electric motor at the steering wheel. The secondary motor provides the driver with the appropriate resistance and feedback in response to specific user inputs at the steering wheel to mimic the feel of a conventional steering system.

In a steer-by-wire system, a malfunction or failure of a portion of the second assembly may result in an inability to steer the vehicle. As a result, it is desirable to provide the second assembly with structure for providing at least temporary fail-safe operation. US 2006/0042858 A1 discloses a steering apparatus including a steering assembly that includes a handwheel actuator. The handwheel actuator includes a steering shaft for supporting a steering wheel, a gear mechanism and two motors, each for providing a torque to the steering shaft.

GB 2579374 A discloses a steering column assembly for use with a steer-by-wire hand wheel actuator. This assembly utilises a similar dual motor drive system that comprises first and second motors, each having an output driving a respective output gear. Each output gear drives a first gear which is connected to and configured to rotate a shaft of the steering wheel to provide a sensation of road feel to the driver. The dual motor drive system is used to reduce gear rattle by driving both motors at the same time to apply opposing torques to the steering shaft. Having two motors also provides for some redundancy in the system.

Typically, these applications utilise Permanent Magnet Synchronous Motors (PMSMs) due to their impressive torque density and dynamic response times. PMSMs are conventionally designed with a slotted stator defining a set of teeth due to cost and packaging constraints, with a rotor carrying a set of permanent magnets. The permanent magnets may therefore form part of the rotor, and the stator comprises soft magnetic material surrounded by coils of wire, but the reverse configuration is also possible. “Soft” magnetic material refers to highly permeable materials commonly used in motor construction.

One significant problem for this type of motor, and indeed many other types of motor, is torque ripple. Torque ripple describes the variance of output torque of a motor as it rotates with a constant supply current.

One source of torque ripple for an electric motor is the position sensing assembly that provides a signal indicating the angular position of a rotating motor rotor or the linear position of a linearly moving motor translator. In a permanent magnet motor the position must be known in order to ensure that the correct current is applied to each phase at any given motor position and for any demanded motor torque. An angle sensing assembly may be provided that has an encoder target, typically a disk, that rotates with the motor rotor and a sensor that reads the position of the encoder target to generate a signal indicative of the rotor angular position Such sensors are very well known and typically use magnetic sensors to detect the position of an encoder that has a plurality of magnets on a support carrier. Similar targets are known for linear motors which translate rather than rotate.

If there are errors in the position signal output from the angle sensing assembly that vary over a mechanical rotation of the rotor these will produce unwanted torque ripple because the currents applied to each phase of the motor, and the timing at which the currents are switched as the motor rotates will deviate from the ideal. As this same deviation will occur during each rotation, torque ripple will be produced.

An example of a motor position sensor which is known to suffer from errors is a dual channel magnetic encoder in which there is an encoder target that carries two concentric tracks of alternating North and South magnetic poles magnetized upon a carrier, such as a disk, which is fixed so that it rotates with the motor rotor. For a linear motor the same arrangement would use two parallel tracks on a carrier. Magnetic field sensors are fixed relative to the stator so that they do not move with the disk, positioned so that the magnets pass close by the sensors as the disk rotates exposing the sensors to an alternating magnetic field. Several sensors may be provided for each track, each of which detects when an edge of a magnetic pole passes the sensor as the encoder rotates. By appropriate sizing and spacing of the magnetic poles and the field sensors it is possible to determine the angle by which the disc has rotated. These encoders may be arranged as incremental encoders where a count of the magnetic pole edges passing the field sensors is used to determine position, or an absolute position encoder in which at any given time the output from the sensors provides a unique indication of position. For high angular resolution incremental encoders are most commonly used.

Errors in the position signal output from encoders of this type arise due to magnets of the encoder being imperfectly magnetized, and due to the magnetic field produced by the magnetic poles in one of the concentric tracks interfering with the magnetic field from the magnetic poles of the other concentric track. This interference causes the edges of the magnetic poles, as detected by the field sensors, to deviate from their ideal locations.

There are many other types of magnetic and non-magnetic angle sensors which might be used to detect motor rotor positions, and all will suffer from angle errors due to manufacturing tolerances and other physical effects. These errors will introduce torque ripple to the output of the motor when used as part of the motor control strategy.

### SUMMARY

The present disclosure seeks to ameliorate the problems associated with conventional motor assemblies that employ motor rotor angle sensor assemblies which are imperfect, and which otherwise may be a source of unwanted torque ripple when a motor is being driven.

In accordance with a first aspect of the present disclosure, a motor drive assembly comprising at least two electric motor subassemblies is provided, each sub-assembly comprising a rotor and a stator. The rotors are connected to a mechanical load such that there is a fixed positional relationship between the two rotors. The system further comprises:
a first position sensing assembly that provides a first rotor position signal indicative of a position of the rotor of a first one of the motor subassemblies;
a second position sensing arrangement that provides a second rotor position signal indicative of the r position of the rotor of a second one of the motor sub-assemblies,
each rotor position sensing assembly producing a position signal indicative of the position of the associated rotor to its associated stator, the signal including a periodic pattern of errors in the indicated position of the rotor of the associated motor subassembly, and
a motor controller which controls currents applied to each motor subassembly as a function of the position signal from the associated rotor position sensing assembly, the current in turn causing the rotor of each motor sub assembly to apply a force or torque to the mechanical load which includes a ripple due to the periodic errors in position signals,

in which:

an orientation of the first rotor a position sensing assembly relative to the first motor subassembly and the orientation of the second rotor position sensing assembly relative to the second motor sub assembly are fixed such that the periodic ripple in the force or torque applied by the two motors are seen by the mechanical load at least partially cancel out.

The applicant has appreciated that the effect of ripple in the position signals to create a corresponding ripple in the torque generated by a motor sub-assembly and that the overall effect can be reduced or completely cancelled out by an appropriate orientation of the two sensors relative to the motor subassemblies. Most ripple is inherent in the design of a position sensor, and so each sensor will perform the same. In the past sensors have always been aligned in the same way for ease of assembly and so the applicant has appreciated that any ripple will be reinforced at the output. By changing the way sensors are aligned this ripple can be greatly improved.

Each motor sub assembly may comprise a rotary motor or a linear motor. Where they are rotary motors, the position sensors may be angular position sensors. Where the motor is a linear motor, the position sensors may measure translation of the rotor.

Each motor sub assembly may comprise a complete motor with a dedicated rotor and stator. Each motor sub assembly may define a permanent magnet synchronous motor where the stator comprises a plurality of windings and the rotor a plurality of permanent magnets. The disclosure may also apply to other motor types.

The mechanical load may comprise a rotatable shaft, such as a steering shaft of a drive by wire steering assembly. Each rotor may be directly connected to that common shaft through a respective gearset. This mechanical connection of the two rotors through the load ensures that they both rotate together, allowing of course for any small amount of backlash that may be present in the system. The connection should ensure that the rate of rotation of the two motor rotors is matched so that one full rotation of one rotor matches a full rotation of the other.

In an alternative, rather than using two motors, each with its own sensor and each connected to the mechanical load through a gearset, the two motor subassemblies may share a common rotor and form a dual lane motor. In a dual lane motor, a motor has two stators and a common rotor, each stator comprising a set of electrical windings and the rotor comprising one or more sets of magnets that interact with the two stators. This can be extended to three or more motors to give three or more lanes.

In this case of a dual lane motor, only a single connection to the mechanical load is required, and the commonality of the rotor shaft parts ensure the two motors always rotate together.

Each stator may comprise set of windings that can be controlled independently. Each of the two stators may have an associated sensor that measures the angular position of the shared rotor relative to the stator. The relative positions of the sensors and the rotor and the stator may be chosen such that the desired cancellation or partial cancellation of ripple is attained.

Where there is only one dual lane motor, in the assembly, the first one of the motor subassemblies may therefore comprise a first lane of the dual lane motor and the second motor may comprise a second lane of the dual lane motor. In this case, the motor may be wound as a dual lane motor, which each lane able to provide torque to the output of the motor, and the first and second rotor sensing arrangements may each sensor a position of the same rotor. The motor controller may drive each lane taking account of signals from a respective one of the two position arrangements.

In addition to dual lane motors, the disclosure will also be applicable to motors having more than two lanes, with one position arrangement for each lane.

The disclosure also applies to systems where there are two or more motors connected to the common mechanical load, and where each motor is also a dual lane motor or each has more than two lanes. Any combination of single and dual (or higher) lane motors can also be realised within the scope of the present disclosure.

Where there is more than one motor, each having its own rotor connected to the load, the first and second rotor sensing arrangements may sense the position of a respective motor rotor.

Each motor angular position sensor assembly may comprise an encoder target that is secured to the rotor of an associated motor subassembly. For a rotary motor this may take the form of an encoder disk and may be fixed to the rotor such that the disk and rotor share a common axis of rotation. Thus, for two motor subassemblies there will be two encoders, with one associated with each motor subassembly, each encoder fixed to the rotor of a respective one of the motor subassemblies.

The encoder target may comprise a set of magnetic encoder elements supported by a substrate, or may comprise non-magnetic elements. Where the elements are magnets, the r position sensing assembly may include a sensor that is able to detect the movement of the magnets relative to the sensor such as a Hall Effect sensor. For non-magnetic encoder elements, other types of sensor may be used such as inductive type sensors or optical sensors.

The encoder may comprise a rotary encoder or may comprise a linear encoder. The rotary encoder is well suited to measuring the angle of a rotor of a rotatry motor. A linear encoder can be used with a rotary motor by conversion of the rotary motion of the rotor to a linear motion, but may also be used where the motor is a linear device and the rotor translates rather than rotates. The skilled person will understand that the term motor sub-assembly covers both rotary and linear machines in this disclosure.

Each motor angular position sensor may further comprise a discrete sensor that may be fixed in position relative to the stator of a motor sub assembly, the sensor detecting the position of the encoder and hence the relative position of the rotor and the stator.

The relative angular positions of the two angular position sensing assemblies may be set by the relative orientation of the encoder and the rotor and by the relative position of the sensor and the stator.

In one exemplary arrangement, the ripple may be at least partially cancelled by fixing the sensors in the same position relative to the stators but changing the relative orientation of the encodes and their respective rotors.

Thus, with the two motor rotors having the same orientation relative to their stators, the encoders will be angularly offset. This may be set to an amount that is dependent on the period of the error signal associated with the encoder. Each encoder will output an angular position with the same error pattern but with the patterns offset. In turn this will cause each motor subassembly to produce the same torque ripple pattern but with an offset that will cause them to at least partially cancel each other out at the shaft.

Each angular position sensor assembly may have a respective encoder and sensor. Where the motor subassemblies are discrete motors which their own rotors, each rotor may be provided with an encoder.

Where the motor subassemblies share a common rotor, as with the dual lane motor, the angular position sensor assembly may also share components. Two sensor assemblies may share a single encoder but have dedicated sensors that detect passing of the encoder. The required cancellation of the ripple can be obtained by suitable selection of the position of the sensors relative to the two stators of the two motor subassemblies.

The offset may be chosen to be equal to one half of the period of the ripple in the output so that the ripple from the two position signals is in anti-phase.

Where each motor sub assembly has a dedicated rotor, the two rotors may each be connected to the shaft by a gearset. For example, the shaft may be fixed to a first gear connected to and configured to rotate with the shaft, and each motor may be connected to the first gear through a respective output gear. These output gears may comprise worm gears and the first gear a worm wheel.

In exemplary arrangements where gears are provided, both motors drive the shaft through the same gear ratio. A rotation of one motor sub assembly though 360 degrees mechanical will result in a matching rotation of the other also through 360 degrees.

The motor sub-assemblies may be electrically identical, as may be the component parts of the motor rotor angular position sensors.

In an arrangement with a common encoder such as an encoder disk, the angular positions of the two sensors relative to the encoder disk and hence relative to the stator of the associated motor may be different to cause each motor to produce the same, but offset, patterns of torque ripple that at least partially cancel each other at the shared rotor. The sensors for each motor can be the same, with only the location at which they are positioned relative to the stators changing. As there is only one disk, the relative position of the disk used by each encoder to the common rotor will be the same for both motors.

The/or each encoder may provide a periodic pattern of errors in the position signal that varies periodically over a revolution of the encoder.

Each encoder, or the encoder where there is one encoder shared by two motor rotors, may comprise at least one annular track of encoder regions. These may comprise permanent magnets, and a track may comprise an alternating sequence of North and South magnet poles. Each magnet may have the same length as the others in the track with the spacing between magnets the same for each pair of adjacent magnets.

Where the track comprises magnets, the sensor may comprise a Hall effect sensor or other device that is sensitive to changes in magnetic field.

The rotating magnetised assembly may take a range of forms and generally comprises a set of alternating north and south magnetic poles spaced around annular tracks, for example two concentric tracks.

Magnetic field sensors may be positioned so as to sense the field form each track. The output from the sensors may be combined to generate the angular position signal. It is known that the magnetic interference between the magnetic fields from one track and that of the other can create the unwanted errors in position measurement. This can lead to a periodic error in the position signal that is the same for all sensor assemblies produced using the same rotating magnetised assembly.

In the example of the angle sensing arrangement comprising of an outer track of 32 magnetic poles and an inner track of 8 magnetic poles, with the two interfering to produce a pattern of position errors that repeats four times over a full rotation of the encoder disk, the two encoder disks may be offset relative to each other for all positions of the motor subassemblies by 45 degrees relative to their respective motor sub-assemblies to provide a good level of cancellation of the torque ripple from the motors, i.e., half of the periodicity of the ripple. For this specific arrangement the offset will be equal to one full magnet pole of the inner track.

Where each encoder has a respective encoder disk, the two encoder disks may be identical so that each sensor assembly generates the same or substantially the same period pattern of errors over a full 360 degree mechanical rotation of the rotor. Where the position signal errors are part of the design rather than due to production tolerances, as is the case where two tracks of magnets interfere, the variation in error around the disk will be the same from disk to disk. This allows the preferred angular offset to be determined during the design process of the dual motor drive assembly as the pattern is known and repeatable.

The dual motor drive assembly may form part of a handwheel actuator assembly for a vehicle, where the shaft includes a fixing part whereby it can be fixed to a steering wheel or yoke.

In one exemplary arrangement, the motor subassemblies are substantially identical and are connected to the output shaft using an identical gear ratio, and also preferably the encoders are identical apart from the orientation of the encoder disks relative to the rotor or stator of each motor as explained above.

### BRIEF DESCRIPTION OF THE DRAWINGS

By way of example only, an exemplary arrangement of the present disclosure incorporated into a handwheel actuator assembly for a vehicle will now be described with reference to the accompanying drawings, in which:

FIG. 1 is a schematic of a first general arrangement of a motor drive system of the present disclosure;

FIG. 2 is a schematic of a second general arrangement of a motor drive system of the present disclosure;

FIG. 3 shows a perspective view of an exemplary arrangement of a handwheel actuator assembly for a vehicle that includes a dual motor drive apparatus in accordance with a first aspect of the present disclosure and which is arranged according to the first general arrangement of FIG. 1;

FIG. 4 shows a part of the dual motor drive apparatus with the gearbox housing removed to better show the gears and the motor connection to the gears;

FIG. 5 is a cross section view of each of the two motors of the apparatus of FIG. 1 illustrating the location of the magnets, the stator teeth, and the electrical connections of the phase windings;

FIG. 6 is an isometric view of one of the motors showing the location an encoder that outputs a signal indicative of the angular position of the rotor and the associated circuitry of the encoder;

FIG. 7 is a schematic of the circuitry of one of the encoders;

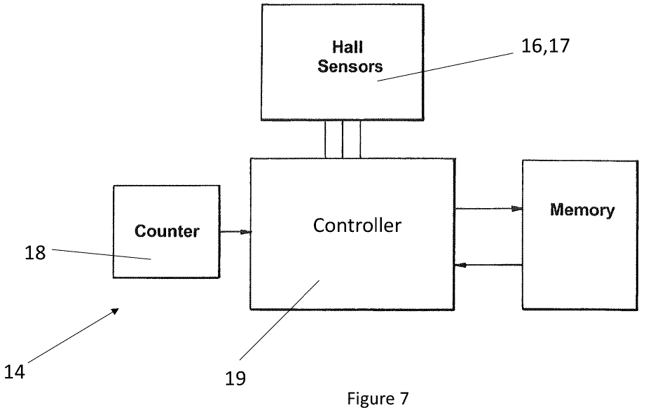

FIG. 8 shows the relative position of the two sensor devices and the encoder disk for one of the encoders in FIG. 1;

FIG. 9 shows the periodic variation in the angle error in the output of an encoder due to magnetic interference between the two tracks;

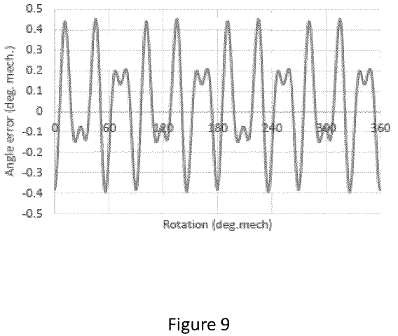

FIG. 10 is a view of the relative orientation of the encoder disks and sensors of the two encoders in a first arrangement in accordance with the present disclosure;

FIGS. 11 and 12 each show an angle error output from the two encoders relative to the angular position of the rotor of each motor;

FIG. 13 shows a total torque ripple at the output shaft when both motors are driven to apply the same notional torque to the shaft overlaid with the same torque ripple with and without an offset of the encoders;

FIG. 14 shows an alternative arrangement of the sensor and a common encoder for use where two sub-motors are provided to define two lanes of a multi-lane motor which share a common rotor and have a common housing in which the sensors are offset; and

FIG. 15 shows an electrical arrangement of two motor subassemblies on a common shaft in accordance with the general arrangement of FIG. 2 and using a shared rotor for use with the encoders of FIG. 12.

### DETAILED DESCRIPTION

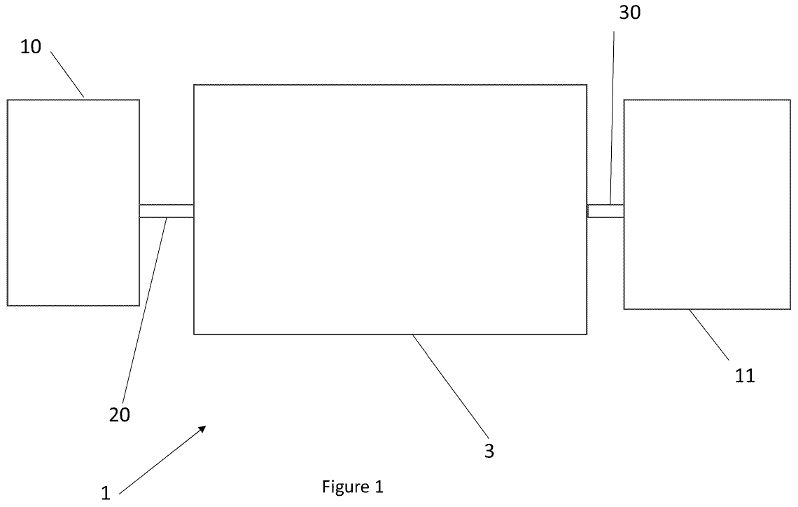

As shown in FIG. 1, a motor drive system 1 in accordance with an aspect of the disclosure comprises two electric motor subassemblies 10, 11. Each sub-assembly comprises a rotor 20, 30 and a stator (not shown in FIG. 1), the rotors being connected to a common mechanical load such that there is a fixed angular relationship between the two rotors. This load may be a shaft 3 and the two motor sub-assemblies 10, 11 may be connected to that shaft through a set of gears. In this example the motors are rotary motors.

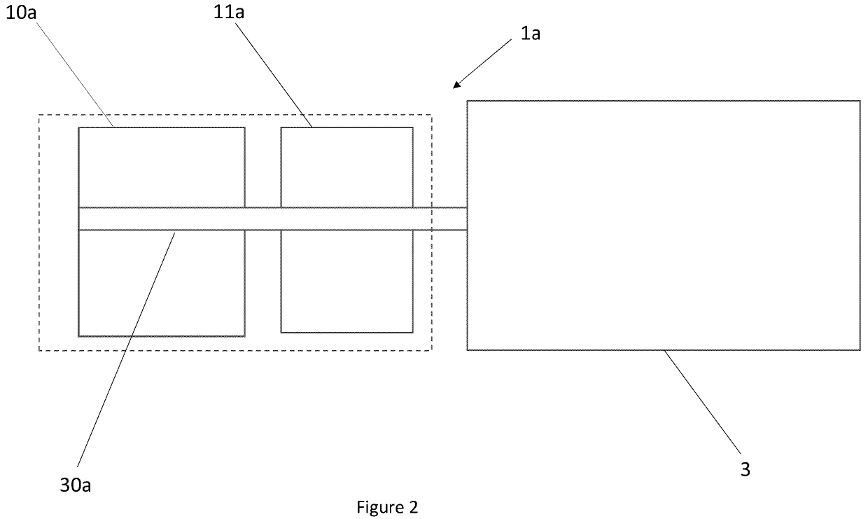

FIG. 2 show an alternative arrangement of a motor drive system 1a configured so that the two motor sub assemblies 10a, 11a are parts of a single motor (indicated by the dashed outline). In this arrangement the two sub-assemblies share a common rotor 30a connected to the load 3. Note that the two sub-assemblies are shown axially spaced along the rotor 30a. These sub-assemblies could, in an alternative arrangement, be arranged concentrically around the rotor 30a.

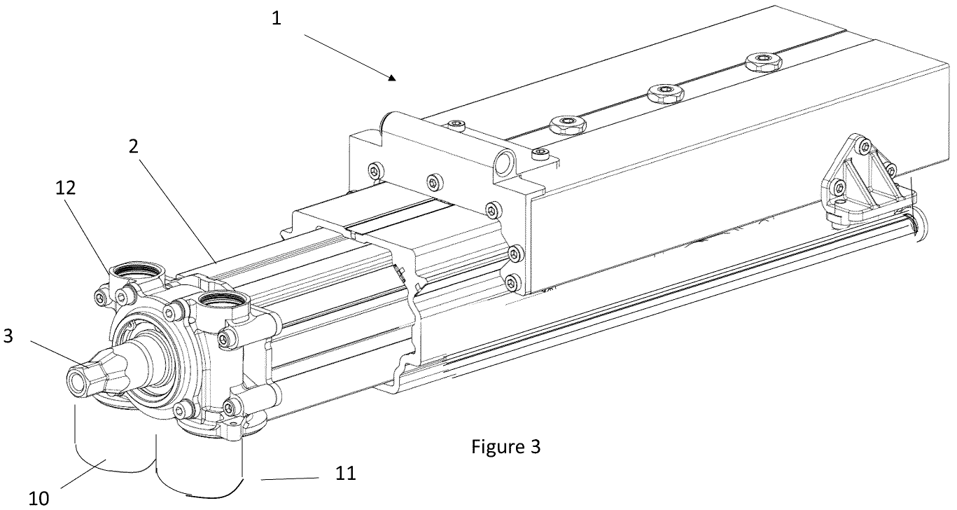

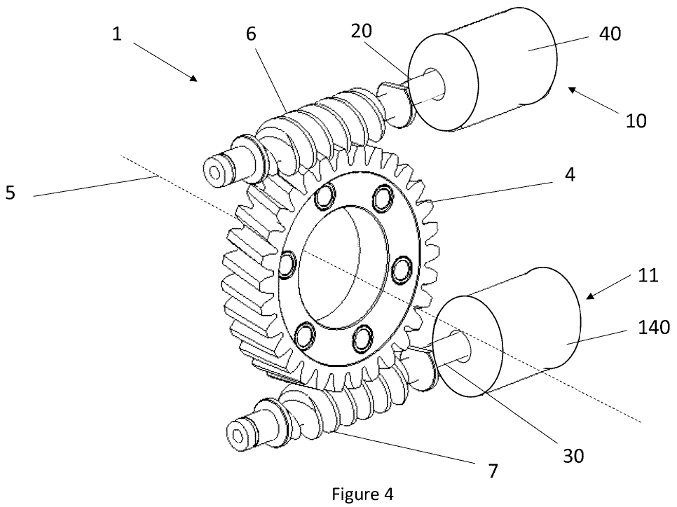

FIGS. 3 and 4 show an example of a general arrangement of FIG. 1 in more detail. The motor drive system of FIG. 3 comprises a steer-by-wire hand wheel system for a vehicle. More specifically, the motor drive system comprises an actuator 1 that comprises an external elongate metal housing 2 which encloses an elongate void. A shaft 3 to which a steering wheel (not shown) is connected passes through one end of the metal housing 2 and an end of the shaft 3 is radially supported on bearings (not show) located at one end of the housing 2. The shaft 3 acts as a mechanical load that provides a fixed relationship between the rotors of the two motors 10, 11.

As best seen in FIG. 4 a gear wheel 4 is secured to the end of the shaft 3 and rotates with the shaft 3. The shaft 3 is not shown in FIG. 4 but the axis of rotation of the shaft 3 is marked using a dashed line 5, extending perpendicularly through the gear wheel 4. The periphery of the gear wheel 4 is formed as a worm gear which meshes with each of two identical worm screws 6, 7 located on opposite sides of the longitudinal axis 5 of the shaft 3. Each worm screw 6, 7 is connected to an output shaft or rotor 20, 30 of a respective electric motor sub assembly 10, 11.

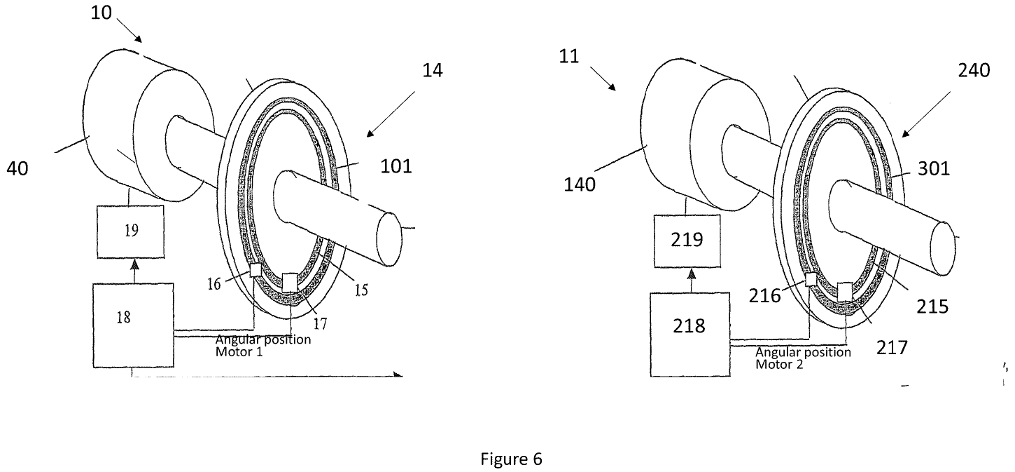

The axes of the output shafts and their rotors 20, 30 of the two motor subassemblies 10, 11 are arranged perpendicularly to the rotational axis 5 of the shaft 3 and, as best seen in FIGS. 4 and 6, the axes of the two motors 10, 11 may also be inclined with respect to each other, to reduce the overall size of the assembly. As best seen in FIG. 1, the motors 10, 11 are received in a transversely extending two-part extension of the housing 2.

The motor subassemblies 10, 11 are controlled by an electronic control unit (ECU) so that at low levels of input torque applied to the shaft 3 by the steering wheel, they act in opposite directions on the gear wheel 4 to eliminate backlash. At higher levels of input torque applied to the shaft 3 by the steering wheel, the motors 10, 11 act in the same direction on the gear wheel 4 to assist in rotation of the shaft 3.

The use of two separate motor subassemblies 10, 11 which can be controlled in a first operational mode to apply torque in opposite directions to the gear wheel 4 eliminates the need to control backlash with precision components. In addition, the use of two separate motors 10, 11 which can be controlled in a second operational mode to apply torque in the same direction to the gear wheel 4 allows the motors 10, 11 and gear components to be specified at half the rating of the required total system torque, thereby reducing the size and cost of the assembly.

The arrangement of the two motor subassemblies 10, 11, the shaft 3, the worm screws 6, 7 and the gear wheel 4 together form a dual motor electrical assembly.

As shown in FIG. 4 the first motor subassembly 10 includes a first rotor 20, and a first stator 30. The first motor 10 further includes a first case 40, shown in FIG. 4, which at least partially covers the first rotor 20 and the first stator 30. The first case 40 is secured to a gearbox housing 12 (shown in FIG. 3) which is rigidly mounted to, or integral with the elongated metal housing 2.

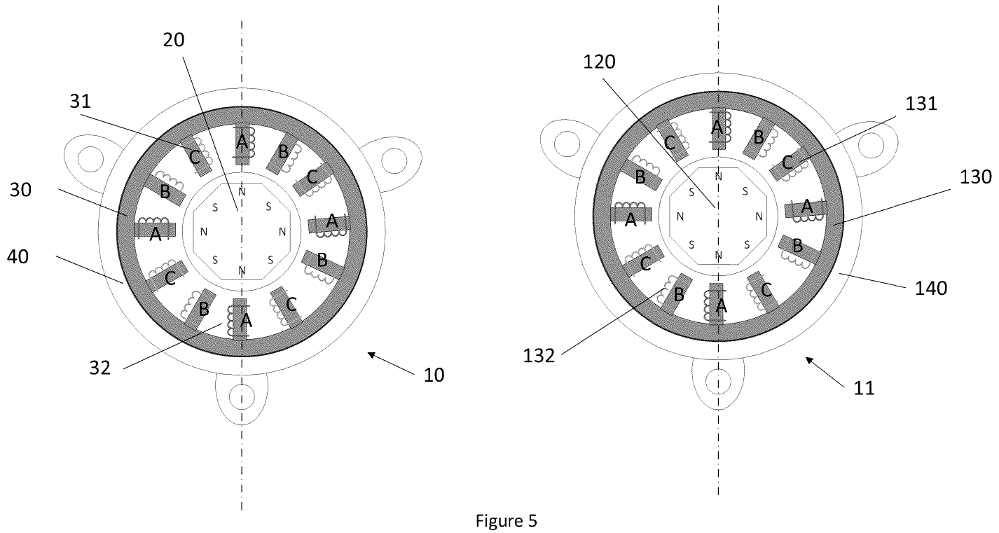

As shown in FIG. 5, the first motor subassembly 10 has twelve stator teeth 31 in this example, and the first rotor 20 carries eight permanent magnets. Each magnet is labelled N for a North pole and S for a South pole, and the North and South poles alternate around the first rotor 20. Each stator tooth 31 is wound with an electrical conductor to form windings 32 such that a current flowing through the windings 32 around a tooth 31 will induce a magnetic field in the tooth 31. The windings 32 are connected to form three motor phases, labelled A, B and C in FIG. 5. The first motor 10 is driven by an inverter which applies current waveforms to each of the three phases of the motor 10 in a known manner. When these drive currents are applied to the phase's electromagnetic interaction between the magnetic field generated at the stator 30 and the field of the rotor permanent magnets can be used to cause the rotor 20 to rotate and for the motor 10 to generate a torque. This torque is applied via the worm screws 6 onto the gear wheel 4 and in turn the shaft 3.

Similarly, the second motor subassembly 11 includes a second rotor 120, a second stator 130 and a second output shaft is rotatably coupled to or is an extended end part of the second rotor 120 at a first end. The second motor subassembly 11 further includes a case 140 as shown in FIG. 4. This case 140 is also secured to the gearbox housing 12 which is rigidly mounted to, or integral with the elongated metal housing 2.

The second motor subassembly 11, shown in FIG. 5, has an identical rotor 120, stator 130 and windings 132 to the first motor 10. The second motor 11 has twelve stator teeth 131 in this example, and the rotor 120 carries eight permanent magnets. Each magnet is labelled N for a North pole and S for a South pole and the North and South poles alternate around the rotor 120. Each stator tooth 131 is wound with electrical conductor to form windings 132 such that a current flowing through the windings 132 around a tooth 131 will induce a magnetic field in the tooth 131. The windings 131 are connected to form three motor phases, labelled A, B and C in FIG. 5. The second motor 11 is driven by a second inverter which applies current waveforms to each of the three phases of the motor 11 in a known manner. When these drive currents are applied to the phase's electromagnetic interaction between the second rotor 120 and the magnetic field generated at the second stator 130 can be used to cause the rotor 120 to rotate and for the motor 11 to generate a torque. This is applied via the worm screw 7 onto the gear wheel 4 and in turn the shaft 3.

The first motor subassembly 10 and the second motor subassembly 11 may be located on diametrically opposite sides of the gear wheel 4 as shown in FIG. 2. Other positions may be used but placing them on opposing sides does provide a compact arrangement and make for convenient connections of the motor phases to the drive circuitry.

To control the motor subassemblies 10, 11, each is provided with a controller which controls an inverter (not shown) that causes each phase to be selectively connected to a positive of negative voltage rial. To ensure the correct timing of the switches, the position of the motor rotor 20, 120 needs to be supplied to the controller. Unless the motor drive scheme is one of the well-known position sensorless schemes, an encoder must be provided which feeds a position signal into the controller indicative of the angular position of the motor rotor 20, 120.

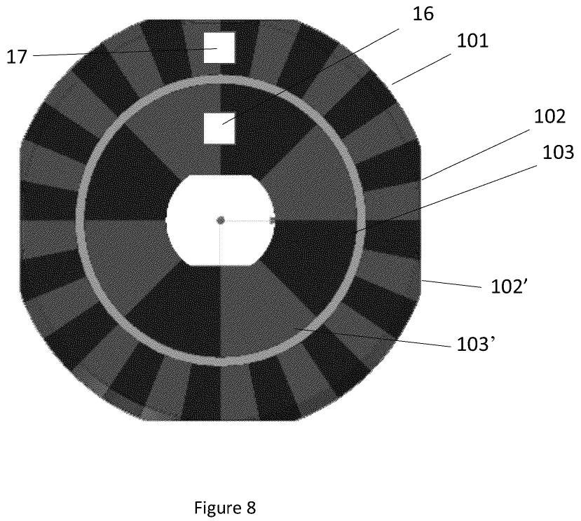

In this exemplary arrangement, each motor subassembly 10, 11 is provided with a respective position encoder target 14, 240. As shown in FIG. 6 one encoder target 14 is connected to the rotor of the first motor subassembly 10 and comprises an encoder disk 101 attached to the output shaft 8 of the motor subassembly 10. The disk 101, may take many forms but in this example is as seen in FIG. 6 and FIG. 8. The disk 101 comprises a track 102 of encoder pole magnets 102′, in this case 32 magnet encoder poles, arranged as an alternating sequence of North and South poles around a circular path. In one exemplary arrangement, each pole magnet has the same width, and the centres of each magnet are spaced from the adjacent magnets centre by 360/32 degrees. Within this track 102 is a second track 103 comprising a further annular track of encoder pole magnets 103′, in this case 8 magnet encoder poles, arranged as an alternating sequence of North and South poles around a circular path of smaller diameter than the first path.

The encoder target 14 includes a support bracket 15 that is fixed in position relative to the motor stator 30 or casing 40 so that it does not move as the encoder disk 101 rotates. The bracket 15 supports two sensor devices 16, 17 that together define one sensor, each device in this exemplary arrangement comprising a Hall Effect sensor. This can be any sensors or a package having multiple sensors inside the active part of each sensor device faces the magnets of a respective one of the tracks so that the output signal from each Hall Effect sensor device 16, 17 will be one of two states depending on whether it “sees” a North Pole or a South Pole on the magnetic encoder track. For convenience the states in are defined here as 1 and 0.

As the rotor of the motor subassembly 10 rotates, the output signal from each of the two sensors 16, 17 will change state according to the polarity of the magnetic track facing the sensors 16, 17. Depending on the direction of rotation, the sensor 16, 17 that sees the edge of a magnetic track first changes. This can be used to determine the direction of rotation. The combined values of the two output signals will change between one of four possible states, the sequence of states depending on the direction of rotation of the encoder disk 101.

The encoder 14 includes a counter 18 and this can be incremented/decremented according to the direction of rotation of the encoder disk 14 as identified from the change of state. The value of the counter 18 is used by a processor 19 as the basis for a measurement of the position of the encoder disk 14 and it is this position measurement that is fed to the motor controller 19 for the motor 10. The motor control uses this signal in determining the current waveforms to be applied to each phase of the motor 10.

In reality, the state transitions will not occur at the expected points around the encoder track, with error present due to, amongst other things, the magnets 102′ on the outer track 102 interfering with the magnetic field of the magnets 103′ on the inner annular track 103 and vice versa. This error will repeat around the encoder disk 101. An example of this potential error can be seen in FIG. 8.

Because the error is inherent in the design it will be the same from one disk 101 to another. Each sensor 16, 17 will feed a position signal to the controller that includes a pattern of error that repeats multiple times around a full rotation of the disk 14. This will cause the motor output to include a torque ripple whenever it is being driven. The ripple the position is shown in FIG. 8.

The second motor subassembly 11 is provided with an identical encoder although as will be explained below the orientation of the component parts of the two encoders 14, 240 differ from one motor to the other. For convenience like reference numerals have been used to denote like parts albeit each incremented by 200. The description above of the arrangement for the first encoder applies equally to the second one.

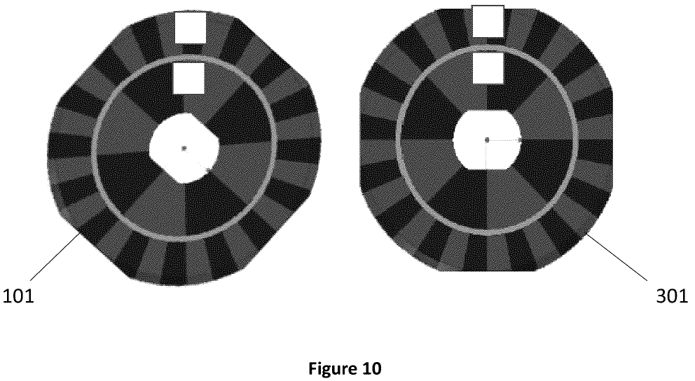

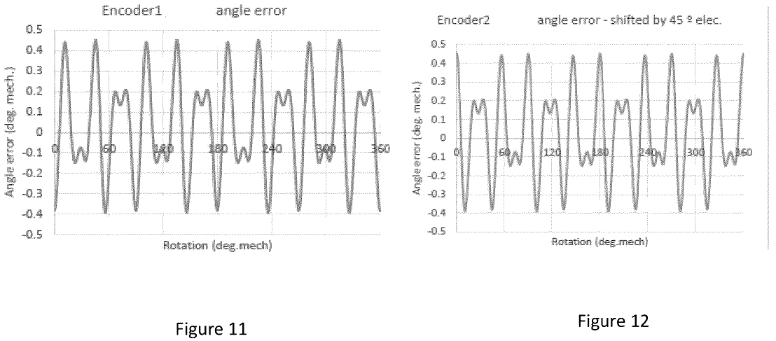

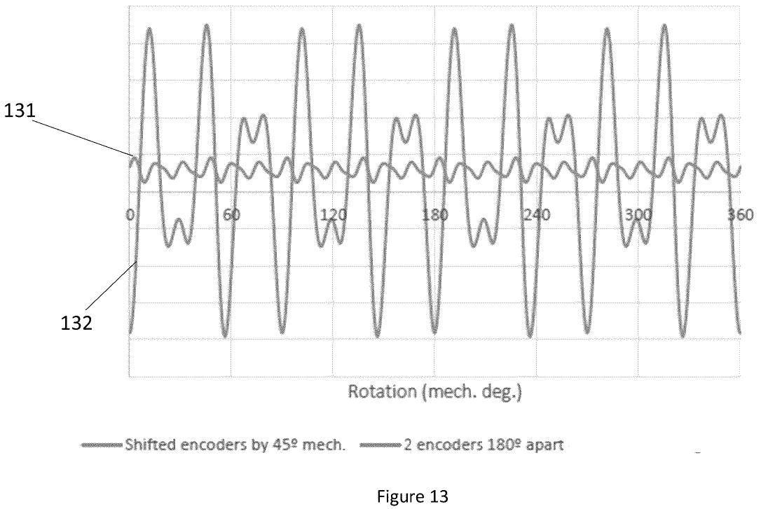

FIG. 10 illustrates where the alignment of the parts of the encoders 101, 301 vary. For example, as can be seen the two encoder disks 101, 301 are oriented differently relative to the motor rotors 20, 120 whilst the sensors are fixed in identical positions relative to the stators such that for the same change in angular position of the two rotors the error pattern generated by one encoder 14 is offset from the identical pattern generated by the other encoder 240. In this example the offset is chosen to be equal to one magnet pole of the inner track, 45 degrees. The applicant has found that this provides a good deal of cancellation of the torque ripple from one motor 10, 11 by the torque ripple of the other motor 10, 11, leading to a reduced overall ripple at the shaft 3. FIGS. 11 and 12 show the error in angular position from the first encoder 14 and the second one 240, the two clearly being offset by 45 degrees. FIG. 13 shows the combined torque ripple present on the shaft 3 with the offset indicated by trace 131 and without the offset indicated by trace 132.

Since the shaft 3 is connected to a steering wheel, the reduction in overall ripple will give an improved smooth steering feel to the driver as the wheel is turned whilst the motors 10, 11 are being driven.

The disclosure is not restricted to the details of the foregoing exemplary arrangement.

Many alternative arrangements are possible within the scope of this disclosure.

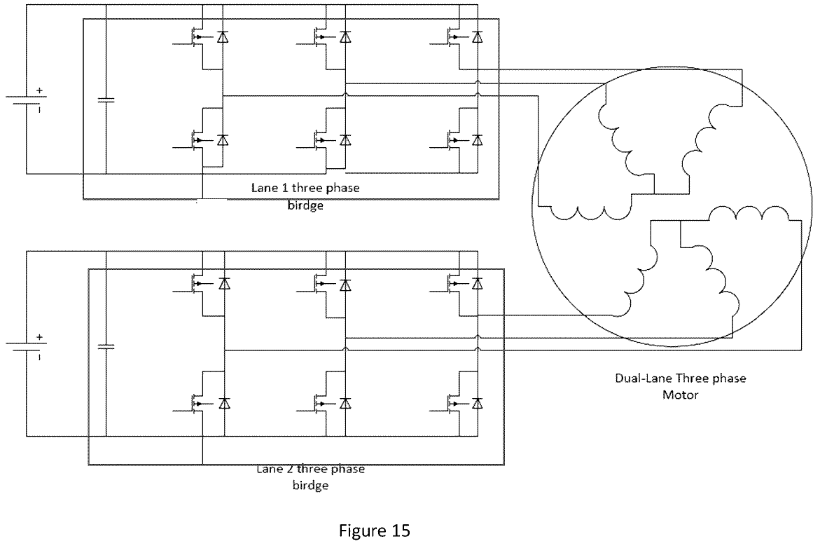

For example, FIG. 15 shows an arrangement in which the two motor subassemblies for a part of single dual lane motor as shown in the general arrangement of FIG. 2. The motor has one rotor and two sets of independent stator windings, each set controlled independently by the motor controller using a respective three phase bridge. Two rotor angular position sensor assemblies are provided, each offset from the other to at least partially cancel any ripple.

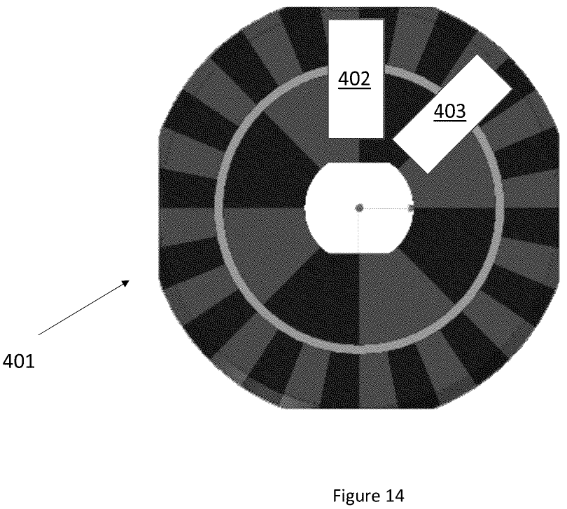

The angular position sensors for the two motor subassemblies may share parts, for example sharing a common encoder disk 401 with each encoder having a respective sensor that is aligned with the encoder disk. Each sensor may comprise two Hall effect devices, one per track, as for the first embodiment. As shown in FIG. 14 the sensor 402 for the first motor may be offset relative to the sensor 403 of the second motor by the same 45 degrees used in the first exemplary arrangement so that the motors 10a, 11a generate respective torque ripples due to encoder disk error that at least partially cancel each other out.

1. A motor drive system, comprising:
at least two electric motor subassemblies, each sub-assembly comprising a rotor and a stator, the rotors being connected to a mechanical load such that there is a fixed positional relationship between the two rotors, the system further comprising:
a first position sensing assembly that provides a first rotor position signal indicative of a position of the rotor of a first one of the electric motor subassemblies;
a second position sensing arrangement that provides a second rotor position signal indicative of the position of the rotor of a second one of the electric motor sub-assemblies,
each rotor position sensing assembly producing a position signal indicative of the position of the associated rotor relative to its associated stator, the signal including a periodic pattern of errors in an indicated position of the rotor of the associated electric motor subassembly, and
a motor controller which controls currents applied to each electric motor subassembly as a function of the position signal from the associated rotor position sensing assembly, the currents in turn causing the rotor of each electric motor sub assembly to apply a torque or force to the mechanical load which includes a torque or force ripple due to the periodic errors in position signals,
wherein:
an orientation of the first rotor position sensing assembly relative to the first electric motor subassembly and the orientation of the second rotor position sensing assembly relative to the second electric motor sub assembly are fixed such that the periodic ripple in the torques or forces applied by the two motors are seen by the mechanical load at least partially cancel out.

2. A motor drive system according to claim 1, in which each of the rotors in use rotates to generate a torque that acts on the mechanical load.

3. A motor drive system according to claim 1, in which each of the rotors in use translates to generate a force that is applied to the mechanical load.

4. A motor drive system according to claim 1, wherein the torque producing elements are sets of stator teeth on the same electric motor, producing torque upon the same rotor, wherein the currents energizing each set of teeth are controlled separately.

5. A linear motor drive system according to claim 1, wherein the force producing elements are sets of stator teeth on the same motor, producing force upon on the same rotor, where the currents energizing each set of teeth are controlled separately.

6. A motor drive system according to claim 1, in which the mechanical load comprises a rotatable shaft and each rotor is directly connected to the shaft through a respective gearset such that a rate of rotation of the two electric motor rotors is matched so that one full rotation of one rotor matches a full rotation of the other.

7. A motor drive system according to claim 1, wherein any each motor position sensor assembly comprises a sensor sub-assembly that is secured to the rotor of an associated torque or force producing element and a sensor sub-assembly fixed in position relative to the stator of an associated torque or force producing element, the sensor detecting the relative position of the rotor and the stator.

8. A motor drive system according to claim 1, wherein each position sensor provides a similar periodic pattern of errors in the position signal and with the position sensors assembled such that the errors are out of phase and hence the torque or force ripple from their rotors is out of phase and hence when mechanically coupled reduces the total ripple.

9. A motor drive system according to claim 8 in which the ripple is at least partially reduced by fixing components of the position sensing assemblies in a same position relative to their associated stators but with other components fixed in different positions relative to their associated rotors, or by fixing components of the position sensing assemblies in different positions relative to their associated stators but with other components fixed in the same positions relative to their associated rotors.

10. A motor drive system according to claim 2, wherein the torque producing elements are sets of stator teeth on the same electric motor, producing torque upon the same rotor, wherein the currents energizing each set of teeth are controlled separately.

11. A linear motor drive system according to claim 3, wherein the force producing elements are sets of stator teeth on the same motor, producing force upon on the same rotor, where the currents energizing each set of teeth are controlled separately.

12. A motor drive system according to claim 2, wherein the mechanical load comprises a rotatable shaft and each rotor is directly connected to the shaft through a respective gearset such that a rate of rotation of the two electric motor rotors is matched so that one full rotation of one rotor matches a full rotation of the other.

13. A motor drive system according to claim 4, wherein the mechanical load comprises a rotatable shaft and each rotor is directly connected to the shaft through a respective gearset such that a rate of rotation of the two electric motor rotors is matched so that one full rotation of one rotor matches a full rotation of the other.

14. A motor drive system according to claim 2, wherein each motor position sensor assembly comprises a sensor sub-assembly that is secured to the rotor of an associated torque or force producing element and a sensor sub-assembly fixed in position relative to the stator of an associated torque or force producing element, the sensor detecting the relative position of the rotor and the stator.

15. A motor drive system according to claim 2, wherein each position sensor provides a similar periodic pattern of errors in the position signal and with the position sensors assembled such that the errors are out of phase and hence the torque or force ripple from their rotors is out of phase and hence when mechanically coupled reduces the total ripple.
